(19) United States
(12) Patent Application Publication
(10) Pub. No.: US 2016/0351175 A1
(43) Pub. Date: Dec. 1, 2016

(54) Clawjammer finger pick

(71) Applicant: Robert Torgler, Virginia Beach, VA (US)

(72) Inventor: Robert Torgler, Virginia Beach, VA (US)

(21) Appl. No.: 14/722,090

(22) Filed: May 26, 2015

(51) Int. Cl. G10D 3/16

(52) U.S. Cl. CPC G10D 3/163

(57) ABSTRACT

An enhanced fingerpick which provides two connected blades located on the front and back of the finger thus enabling musicians to upstroke and downstroke with the same fingerpick, thereby eliminating the need to change picks or flip them around to the other side of their finger. This is accomplished by providing a blade juncture 18 connecting a second blade 12 to the first blade 10 at the tip of the finger enabling the user to strike the strings in either direction with the opposing blades. The dual blades are held onto the finger by a pair of annular arms or wings. The use of the dual blade pick additionally provides added clarity to the tone and increased volume. The pick can be utilized for playing the banjo, guitar, pedal steel guitar, dobro, mandolin, as well as any picked or strummed stringed instrument.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not applicable

### BACKGROUND OF THE INVENTION

(1) Field of the Invention

This invention relates to picks worn on the finger of a musician to pluck, pick, or strum a musical instrument.

(2) Description of Related Art Including Information Disclosed Under 37 CFR 1.97 and 1.98

Conventional fingerpicks have only one blade and, therefore, they are capable of only striking stringed instruments in one direction at a time. These picks terminate near the tip of the finger, regardless of which side of the finger it is worn on, allowing only one direction for picking or strumming. This forces musicians to choose between positioning the blade for an upstroke or downstroke, depending on which side of the finger it is worn on. If the tip of the pick assembly catches a string when trying to perform the opposite movement, then there is the possibility of the string getting lodged between the pick and the finger, or the pick becoming accidentally removed from the finger of the player if the string should catch on the non picking side due to the curved nature of the picking device. This can be especially problematic during live performances. Devices are known that relate to picks for stringed instruments, sometimes referred to as thimbles. These devices, however, fail to provide a dual bladed fingerpick that enables an individual to play alternately on both the upstroke and downstroke in rapid succession with accuracy. Picking devices are known that are suited primarily for a zither, meloflute, or other such instruments that provide the possibility to pick a string in opposing directions, however, due to the narrow nature of their arms and the concave curvature of their extended, flattened tips, these picks are incapable of providing the user with speed, stability and precision, or the ability to strum efficiently. These devices were invented before the musical style of Bluegrass came into existence, and do not facilitate the speed and precision required to play said musical style. Many stringed instrument players who prefer to use fingerpicks instead of their bare fingers, and typically banjo players, are forced to use one style at a time, that is, either the upstroke style or the downstroke style of playing, (often referred to as “three finger” or “Scruggs style” for the upstroke style, and “clawhammer” or “old time” for the downstroke style) and in the past, unless they used their bare fingers with no picks attached, they were forced to pick between one style or the other during the course of a song, as conventional picks only allow for picking in one direction, and thimble devices do not provide precision of string striking or clarity of tone. To change from up picking to down picking, or vice versa, one was forced to stop playing momentarily and flip their picks around, or use another pick suited for either style they presently chose.

### BRIEF SUMMARY OF THE INVENTION

A fingerpick is disclosed for picking, plucking, or strumming the strings of a musical instrument. The pick consists of two connected blades which are positioned on opposite sides of the finger and are held to the finger by annular arms or “wings” that wrap around the finger. The use of the two blades allows a musician to strike the strings in either direction

### BRIEF DESCRIPTION OF THE SEVERAL VIEWS OF THE DRAWINGS(S)

FIG. 1 is a front view of the pick invention after bending with broken lines showing the second blade

FIG. 2 is an overhead view of the pick invention after being cut and removed from the sheet material, but prior to bending into shape

FIG. 2b is an alternate top view of the pick invention after being cut and removed from the sheet material with the second blade as a separate piece

FIG. 3 is a side view of the pick invention after bending as worn on a finger, showing the second blade on the nail side of the finger

FIG. 4 is a top view of the pick invention after bending as worn on a finger, facing the finger tip FIG. 5 is an inside view of the pick invention after bending

### DETAILED DESCRIPTION OF THE INVENTION

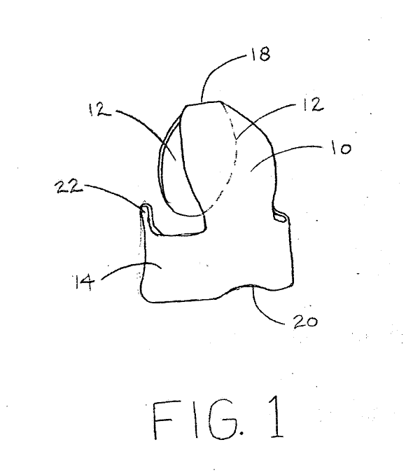

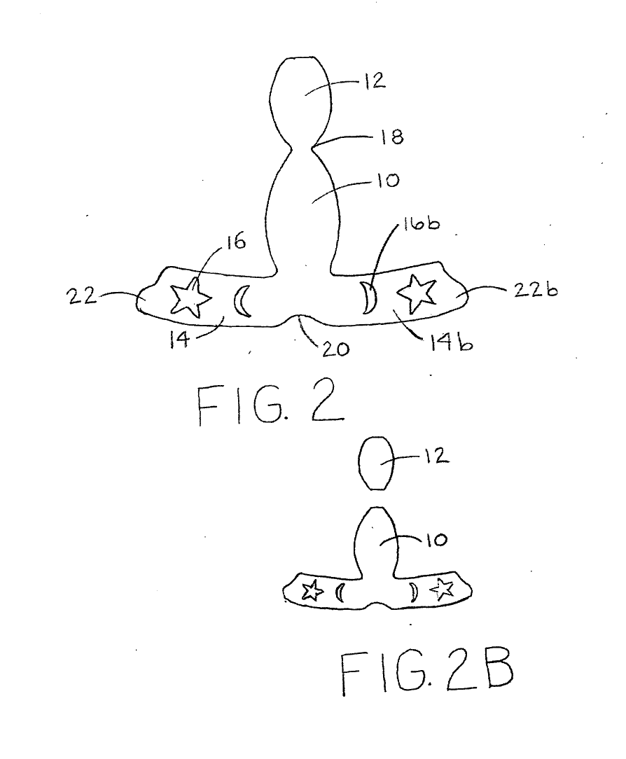

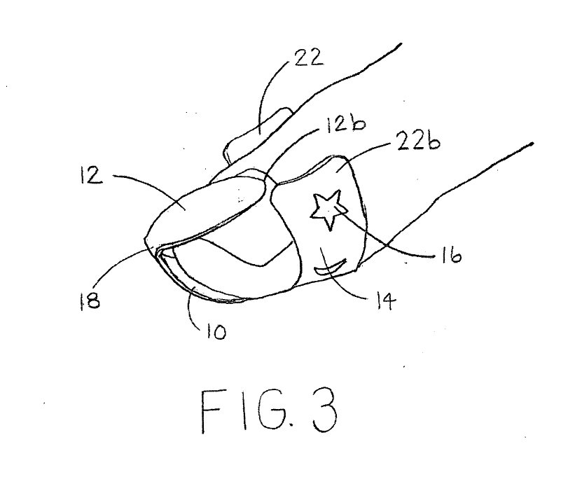

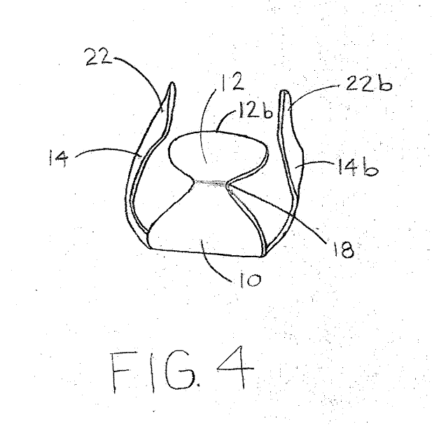

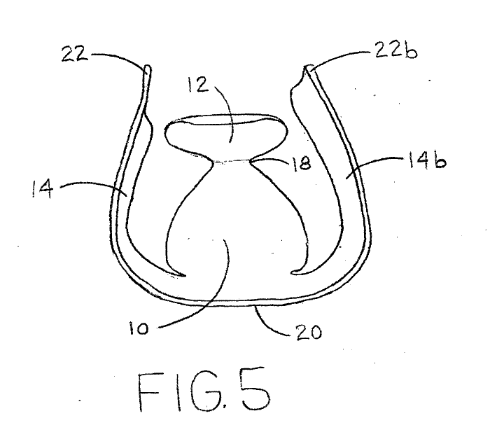

Referring now to FIG. 1, there is displayed a fingerpick according to the first embodiment of this invention from a point view in front of the pick, where the second blade 12 is fully shown with the aid of broken lines. This embodiment provides an enhanced fingerpick for use with stringed instruments. Utilizing the first blade 10 and second blade 12 the fingerpick provides a means for a player to play on both the upstroke and downstroke with a single fingerpick, thereby enabling an individual to play different styles of music, including that of traditional 3 finger bluegrass (upstroke) or claw hammer banjo (downstroke) styles within the same song without requiring the player to alter fingerpick positioning or change picks altogether. The present invention is primarily adapted for use by a banjo player, however the present invention is readily adaptable for other stringed instruments, such as a guitar, mandolin, dobro, pedal steel and the like, thereby providing convenience for all musicians. Referring now to FIG. 2, there is displayed an overhead view of the fingerpick after cutting and removal from the sheet material. The present invention is comprised of a winged fingerpick that is cut from a metal or plastic sheet, which can be composed of many different materials suited to the purpose described as outlined later in this paragraph. The fingerpick shape can be cut out of the sheet by various methods, including but not limited to, hand cut with jewelers saw, hand cut with shears, machine stamped, water jetted, laser jetted, or any method of cutting metals and plastics. Further, the present invention can be made from: stainless steel, nickel silver, sterling silver, brass, copper and the like. The metal may also have an additional coating such as cobalt or similar material to aid in the reduction of string friction and string squeaking. Alternatively, the fingerpick of the present invention can be composed of plastics, celluloid, mylar, delrin, ultem and the like. 16 and 16b represent an embodiment with optional cutouts or perforations which allow more flexibility in the wings, as well as providing extra grip on the finger. These are represented accordingly as stars and moons but can be of any shape, size or designs. These designs can be stamped within the device at the time of the forming of the fingerpick or after the formation of the pick. 20 represents an embodiment with an optional cutout at bottom of the pick, where the wings meet, and performs the function of removing some weight from the pick as well as increasing player comfort. This cut out can be of various shape and size depending on user preference. Referring now to FIG. 2b, there is displayed an overhead view similar to that in FIG. 2 with an alternate embodiment wherein the second blade 12 is detached when removed from the sheet material, whereby an alternate method can be used to connect the first 10 and second 12 blades using solder, resin, epoxy or other suitable methods to secure the two blades together. This embodiment can serve to provide a sharper angle at the blade juncture 18 to provide a more pronounced and brighter tonal variant of the string if desired. Referring now to FIG. 3, there is displayed a view of the side of the fingerpick of the present embodiment showing how it fits on the finger of the user. After removal from the sheet material, the cutout can be formed into the fingerpick shape. The fingerpick includes a first blade 10 which contours over the flesh portion of a finger and a second blade 12 which contours over the fingernail portion of an individual's finger. The first and second blades can be formed during the shaping of the fingerpick to create the blade juncture 18. Alternatively, the second blade can be separately secured to the first blade to create the juncture as earlier referenced in FIG. 2b. The wings or annular bands 14 and 14b can be shaped to hold the pick onto the users finger. The shape and length of the wings 14 and 14b are variable to suit different sized fingers and a players preference. Referring now to FIG. 4, there is displayed a front view of the fingerpick. After removal from the sheet material, the present invention can be filed, sanded, buffed smooth, and bent to fit the finger of an individual, and it is understood that users may then further shape the device specifically to their finger size and shape for a comfortable fit. Traditionally the fingerpick is sized to fit the index and/or middle finger of an individual, but may be used for any finger. The ends of the wings 22 and 22b can be bent upwards to deflect the string during the striking motion, thus preventing it from becoming lodged between the second blade 12 and the fingernail should the user angle the finger while striking the string in such a manner that the string would make contact below the base 12b of the second blade. Referring now to FIG. 5, there is displayed an inside view of the fingerpick. The juncture 18 of blade one 10 blade two 12 can be reinforced to strengthen the juncture. The foregoing descriptions of specific embodiments of the fingerpick have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

### PARTS LIST

10 Blade one
12 Blade two
12b Base of Blade two
14 Wing or annular band
14b Opposing wing or annular band
16 Optional perforation
16b Additional optional perforation
18 Blade juncture
20 Optional cutout or indentation for comfort and weight reduction
22 Area of wing that may be bent outward
22b Opposing side area of wing that may be bent outward

1. A dual bladed pick to be attached to a finger of a user for plucking or strumming the strings of a musical instrument, said pick having wings or annular bands to hold the pick on said finger during play.

2. The pick recited in claim 1, wherein a first blade is connected to said wings or annular bands and contours along the fleshy part of the finger to the tip of the finger and a second blade attaches to the first blade at the tip of the finger and contours over the nail side of the finger, whereby said user uses a first blade to pluck or strum the strings in one direction and a second blade to pluck or strum in the opposing direction.

3. The pick recited in claim 1, wherein the wings or annular bands are bent away from the finger at their ends to prevent the string of a musical instrument from becoming lodged between a second blade and the finger nail.
